(19) United States
(12) Patent Application Publication
(10) Pub. No.: US 2024/0283297 A1
(43) Pub. Date: Aug. 22, 2024

(54) ENERGY HARVESTING FROM BACKGROUND RF SIGNAL

(71) Applicant: Telefonaktiebolaget LM Ericsson (publ), Stockholm (SE)

(72) Inventors: Hamed FARHADI, Stockholm (SE); Henrik RYDÉN, Stockholm (SE)

(21) Appl. No.: 18/571,032

(22) PCT Filed: Jun. 17, 2021
(86) PCT No.: PCT/SE2021/050599

§ 371 Date: Dec. 15, 2023

(51) Int. Cl. H02J 50/20; H02J 50/00; H02J 50/40; H02J 50/80

(52) U.S. Cl. CPC H02J 50/20; H02J 50/001; H02J 50/40; H02J 50/80

(57) ABSTRACT

A method performed by a first network node for enabling a first wireless device to obtain background RF signal energy from background RF signals provided by the first network node and/or at least one second network node in a wireless communications network on a set of time-frequency resources is presented. The first network node estimates a background RF signal energy available to the first wireless device in each time-frequency resource in the set of time-frequency resources. The first network node determines a first subset of the set of time-frequency resources that the first wireless device is to use for obtaining background RF signal energy based on the estimated background RF signal energy. The first network node transmits information indicating the determined first subset of the time-frequency resources to the first wireless device. A network node a first wireless device and method therein are also provided.

### TECHNICAL FIELD

Embodiments herein relate to energy harvesting. In particular, embodiments herein relate to a network node and method therein for enabling a wireless device to obtain background Radio Frequency, RF, signal energy from background RF signals in a wireless communications network. The embodiments herein also relate to a wireless device and method therein for obtaining RF signal energy from background RF signals in a wireless communications network.

### BACKGROUND

In today's wireless communications networks, a number of different technologies for enabling next generation of wireless communications networks is being implemented. Naturally, these next generation wireless communications networks are based upon and evolves from existing telecom technologies, such as, New Radio (NR), Long Term Evolution (LTE), etc.

A wireless communications network conventionally comprises network nodes, e.g. eNB/gNBs, radio base stations, wireless access points, etc., providing radio coverage over at least one respective geographical area forming a cell. This may be referred to as a Radio Access Network, RAN. The cell definition may also incorporate frequency bands used for transmissions, which means that two different cells may cover the same geographical area but using different frequency bands. Wireless devices, also referred to herein as User Equipments, UEs, mobile stations, and/or wireless terminals, are served in the cells by the respective network node and are communicating with respective network node in the RAN. Commonly, the wireless devices transmit data over an air or radio interface to the network nodes in uplink, UL, transmissions and the network nodes transmit data over an air or radio interface to the wireless devices in downlink, DL, transmissions.

In the next generation of wireless communications networks, it is envisioned that the widely spread network infrastructure provided by these networks, along with the significantly increased data transmissions, will enable energy to be wirelessly transferred to a wide range of devices, such as low-power and/or low cost wireless devices. In other words, it is expected that Radio Frequency, RF, signalling in wireless communications networks will be able to be used for transferring energy to the low-power and/or low cost wireless, such as Internet-of-Things, IoT, devices in massive Machine Type Communication, mMTC, scenarios.

In the latter scenarios, the wireless devices may harvest part or all of their required energy from transmitted RF signals. However, due to practical limitations, RF energy harvesting by a wireless device is not feasible for signals intended for decoding, such as, data transmissions intended for the wireless device. Hence, a decoupling between the processes of decoding data transmissions intended for the wireless device and the process of harvesting energy from other transmissions, such as energy harvesting signals, is normally required. Different receiver architectures or functionalities in the wireless devices, such as power splitting, time switching, or antenna switching, etc., may be applied for achieving joint data communication and energy harvesting. For example, a typical energy-harvester in a wireless device may comprise a rectifying circuit, a low-pass filter and a storage device (such as capacitors) that converts received RF power to stored energy.

To perform joint data communication and energy transfer, a transmitter in a network node may transmit a combination of information signals and energy signals and a receiver in a wireless device may attempt to decode the information signal and harvest the energy from the energy signal. Furthermore, to enhance the performance of the data communication or the efficiency of the energy transfer, multiple antennas may be used at the transmitter in the network node to perform so-called beamforming of the transmitted signals towards the receiver in the wireless device. This would, for example, improve the received Signal-to-Noise Ratio, SNR, for the data communication at the receiver in the wireless device, and also increase the amount of the energy that may be received at the receiver in the wireless device for energy harvesting.

With the emergence of IoT, such as described by 5G mMTC use cases connecting billions of low-power and/or low-cost wireless devices, there is a need for new wireless energy transfer technologies to act as an efficient way of charging geographically widespread wireless devices. If implemented, this will also enable sustainable and energy-efficient wireless communications networks and device operations with extended battery-lifetimes for the wireless devices. There are existing trends in attempting to reduce the required processing power per wireless device, while also increasing the efficiency of energy harvesting in each wireless device. This will make wireless energy transfer a feasible technological feature in future wireless communications networks. However, it will require an efficient energy transfer technique to be implemented in the wireless communications network.

### SUMMARY

It is an object of embodiments herein to improve energy transfer in a wireless communications network.

According to a first aspect of embodiments herein, the object is achieved by a method performed by a first network node for enabling a first wireless device to obtain background RF signal energy from background RF signals provided by the first network node and/or at least one second network node in a wireless communications network on a set of time-frequency resources. The method comprises estimating a background RF signal energy available to the first wireless device in each time-frequency resource in the set of time-frequency resources. The method also comprises determining a first subset of the set of time-frequency resources that the first wireless device is to use for obtaining background RF signal energy based on the estimated background RF signal energy. Further, the method comprises transmitting information indicating the determined first subset of the time-frequency resources to the first wireless device.

According to a second aspect of embodiments herein, the object is achieved by a first network node for enabling a first wireless device to obtain background RF signal energy from background RF signals provided by the first network node and/or at least one second network node in a wireless communications network on a set of time-frequency resources. The first network node is configured to estimate a background RF signal energy available to the first wireless device in each time-frequency resource in the set of time-frequency resources. The first network node is also configured to determine a first subset of the set of time-frequency resources that the first wireless device is to use for obtaining background RF signal energy based on the estimated background RF signal energy. Further, the first network node is configured to transmit information indicating the determined first subset of the time-frequency resources to the first wireless device.

According to a third aspect of embodiments herein, the object is achieved by a method performed by a first wireless device for obtaining RF signal energy from background RF signals provided by a first network node and/or at least one second network node in a wireless communications network on a set of time-frequency resources. The method comprises receiving information indicating a first subset of the set of time-frequency resources that the first wireless device is to use for obtaining RF signal energy. The method also comprises obtaining RF signal energy from background RF signals received on the first subset of the set of time-frequency resources.

According to a fourth aspect of embodiments herein, the object is achieved by a first wireless device for obtaining RF signal energy from background RF signals provided by a first network node and/or at least one second network node in a wireless communications network on a set of time-frequency resources. The first wireless device is configured to receive information indicating a first subset of the set of time-frequency resources that the first wireless device is to use for obtaining RF signal energy. The first wireless device is also configured to obtain RF signal energy from background RF signals received on the first subset of the set of time-frequency resources.

According to a fifth aspect of the embodiments herein, a computer program product is also provided configured to perform the method described above. Further, according to a sixth aspect of the embodiments herein, carriers are also provided configured to carry the computer program product configured for performing the method described above.

By enabling a wireless device to obtain background RF signal energy from background RF signals in a wireless communications network as described above, significant amounts of dedicated time, energy and time-frequency resources normally spent using existing energy harvesting techniques for enabling energy transfer to wireless devices in the network may be released and saved. Furthermore, by configuring a wireless device to perform energy harvesting in a time-frequency resource based on a background energy harvesting estimate for said time-frequency resource for the wireless device, knowledge of the most suitable resources for energy harvesting may be obtained by the wireless device. In other words, the wireless device is able to avoid harvesting background energy in time-frequency resources in which there are no or small amounts traffic, i.e. energy to be harvested, or in which there is less energy in comparison to other time-frequency resources. Hence, energy transfer in a wireless communications network is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic block diagram of a wireless communications network comprising a first network node and a first wireless device according to some embodiments,

FIG. 2 is a flowchart depicting embodiments of a method in a first network node,

FIG. 3 is a flowchart depicting embodiments of a method in a first wireless device, is a signalling diagram illustrating embodiments of a first network node, a FIG. 4 first wireless device, and at least one second wireless device in a wireless communications network,

FIG. 5 illustrates a distribution of probing resource blocks in the time-frequency domain according to some embodiments,

FIG. 6 illustrates a background RF signal energy distribution map in the frequency-direction domain according to some embodiments,

FIG. 7 is a block diagram depicting embodiments of a first network node,

FIG. 8 is a block diagram depicting embodiments of a first wireless device.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

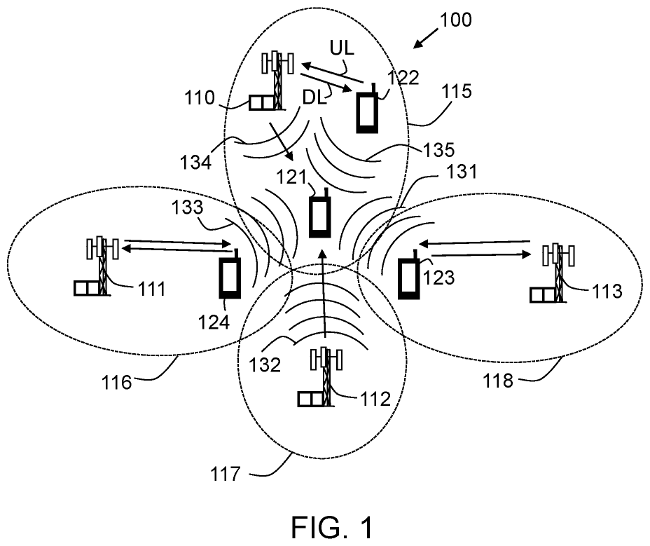

FIG. 1 depicts a wireless communications network 100 in which embodiments herein may operate. In some embodiments, the wireless communications network 100 may be a Radio Access Network, RAN, of a radio communications network, such as, 6G or NR telecommunications network. Although, the wireless communications network 100 is exemplified herein as an 6G or NR RAN, the wireless communications network 100 may also employ technology of any one of 3/4/5G, LTE, LTE-Advanced, WCDMA, GSM/EDGE, WiMax, UMB, GSM, or any other similar network or system. The wireless communications network 100 may also employ technology of an Ultra Dense Network, UDN, which e.g. may transmit on millimetre-waves (mmW).

The wireless communications network 100 comprises a first network node 110 and at least one second network node 111, 112, 113. Each of the first and at least one second network node 110, 111, 112, 113 may serve wireless devices in at least one cell or coverage area 115, 116, 117, 118, respectively. Each of the first and at least one second network node 110, 111, 112, 113 may correspond to any type of network node or radio network node capable of communicating with wireless devices in the wireless communications network 100, such as, a base station (BS), a radio base station, gNB, eNB, eNodeB, a Home NodeB, a Home eNodeB, a femto Base Station (BS), or a pico BS in the wireless communications network 100. Further examples of each of the one or more network nodes 110, 111, 112, 113 are repeaters, multi-standard radio (MSR) radio nodes such as MSR BSs, network controllers, radio network controllers (RNCs), base station controllers (BSCs), relays, donor node controlling relays, base transceiver stations (BTSs), access points (APs), transmission points, transmission nodes, Remote Radio Units (RRUs), Remote Radio Heads (RRHs), nodes in distributed antenna system (DAS), or core network nodes.

In the scenario shown in FIG. 1, a first and a second wireless device 121, 122 are located within range of the first network node 110. The first and second wireless device 121, 122 are configured to communicate within the wireless communications network 100 via the first network node 110 over a radio link served by the first network node 110. In other words, the first and second wireless device 121, 122 may be configured to transmit data over an air or radio interface to the first network node 110 in uplink, UL, transmissions, and the first network node 110 may transmit data over an air or radio interface to the first and second wireless device 121, 122 in downlink, DL, transmissions. Also, third and fourth wireless devices 123, 124 are located within range of the at least one second network nodes 113, 111, respectively. The third and fourth wireless device 123, 124 are configured to communicate within the wireless communications network 100 via the at least one second network nodes 113, 111, respectively, over a radio link served by the at least one second network nodes 113, 111. In other words, third and fourth wireless device 123, 124 may be configured to transmit data over an air or radio interface to the at least one second network nodes 113, 111, respectively, in UL transmissions, and the at least one second network nodes 113, 111 may transmit data over an air or radio interface to the third and fourth wireless device 123, 124, respectively, in DL transmissions. The first, second, third and fourth wireless devices 121, 122, 123, 124 may be any type of wireless devices or user equipments (UEs) communicating with a network node and/or with another wireless device in a cellular, mobile or radio communication network or system. Examples of such wireless devices are mobile phones, cellular phones, Personal Digital Assistants (PDAs), smart phones, tablets, Laptop Mounted Equipment (LME) (e.g. USB), Laptop Embedded Equipments (LEEs), etc. Further examples of such wireless device are IoT devices, sensors equipped with wireless communication capabilities, Machine Type Communication (MTC) devices, Machine to Machine (M2M) devices, Customer Premises Equipment (CPE), target devices, device-to-device (D2D) enabled wireless devices, wireless devices capable of machine to machine (M2M) communication, etc.

In the example scenario shown in FIG. 1, the first wireless device 121 may harvest background RF signal energy from background RF signals 131 corresponding to DL or UL transmissions between the third wireless device 123 and the network node 113 in cell 118. Similarly, the first wireless device 121 may harvest background RF signal energy from background RF signals 133 corresponding to DL or UL transmissions between the fourth wireless device 124 and the network node 111 in cell 116.

Additionally, it should be noted that the first wireless device 121 may harvest background RF signal energy from background RF signals 132 transmitted from the network node 112. In this case, the network node 112 may transmit signals dedicated for energy harvesting towards wireless devices, such as the first wireless device 121. Furthermore, it should also be noted the first wireless device 121 may also harvest background RF signal energy from background RF signals 135 corresponding to DL or UL transmissions between the second wireless device 122 and the network node 110 in cell 115, as well as, harvest background RF signal energy from background RF signals 134 transmitted from the network node 110. In the latter case, the network node 110 may transmit signals dedicated for energy harvesting towards wireless devices, such as the first wireless device 121.

It should be noted that the scenario described in reference to FIG. 1 is only one example of a scenario in which the embodiments described herein are applicable, and should therefore not be construed as limiting, but only to serve a general example by which the different embodiments herein may be best described.

As part of the developing of the embodiments described herein, it has been realized that existing wireless RF energy transfer techniques conventionally requires that the network nodes in the wireless communications network spend dedicated amounts of energy and time-frequency resources for each energy harvesting wireless device. This causes a lot of unnecessary energy to be spent in the wireless communications network, since only energy is transmitted in the signals towards the energy harvesting wireless device and no actual data. An alternative is for the energy harvesting wireless device to instead make use of and harvest available background RF signal energy in the form of transmitted signals and/or energy that is intended for other wireless devices in the wireless communications network. However, due to the lack of knowledge of the data traffic to/from the network nodes in the wireless communications network, an energy harvesting wireless device is not aware of in which time-frequency resources there are any background RF signal energy suitable to harvest, and is not aware of the amounts of background RF signal energy that is available in each of the time-frequency resources. Therefore, an energy harvesting device may unnecessarily spend time and energy in attempting to harvest background RF signal energy in time-frequency resources in which there is no or only small amounts of background RF signal energy, i.e. low data traffic. For example, an energy harvesting device may attempt to harvest background RF signal energy in a first set of time-frequency resources, e.g. on a first radio carrier, in which there is less background RF signal energy available than in another set of time-frequency resources, e.g. on a second radio carrier. In general, due to the network densification and deployment of a vast number of carriers in existing and developing wireless communications networks, it is challenging for an energy harvesting device to locate the most suitable time-frequency resources in which to harvest background RF signal energy.

According to the embodiments described herein, a wireless device may be configured by its serving network node in a wireless communications network to perform background RF signal energy harvesting in time-frequency resources based on a background RF signal energy harvesting estimate for said time-frequency resource. In other words, the network node may find the most suitable or optimal time-frequency resources for a specific wireless device to perform background RF signal energy harvesting on. The most suitable or optimal time-frequency resources may here, for example, be considered to be the time-frequency resources which maximizes the background RF signal energy to be harvested by the wireless device; this, for example, without its serving network node having to transmit dedicated energy signals towards the wireless device.

It should also be noted that since a wireless device is not aware of the data traffic in the network nodes, it is also not aware of where there is RF signal energy to harvest. According to the embodiments herein, the wireless device may be configured with time-frequency resources in which there are lot of expected energy to be harvested. Since the network nodes does not need to spend extra energy in transmitting dedicated energy towards an energy harvesting wireless device, the energy efficiency within the wireless communications network is improved. Further energy efficiency is also achieved in that a selection between certain frequency carriers may be made. For example, some frequency carriers may be more suitable for data communication, e.g. by experiencing less interference, and some frequency carriers may be more suitable for energy harvesting, e.g. by comprising more energy due to higher data traffic, more interference, etc.

Another advantage of the embodiments herein is that background RF signal energy from data traffic that anyway will be transmitted to other wireless devices may be used by an energy harvesting wireless device located in the vicinity of the other wireless devices. This means that there is less of a need for the network nodes to send only RF signal energy (without any data) towards the wireless device. Less energy spent on only RF signals will also lead to reduced interference in the wireless communications network.

Furthermore, since the network node may predict or estimate time-frequency resources/carriers that will provide the highest amount of background RF signal energy for the wireless device to harvest, the network node may signal these to the energy harvesting wireless device such that the energy harvesting wireless device only will attempt to harvest RF signal energy in time-frequency resources/carriers in which there is expected to be a high level of background RF signal energy. This will improve the energy harvesting of the energy harvesting wireless device, since it will reduce the time spent by the energy harvesting wireless device on attempting to harvest RF signal energy in time-frequency resources/carriers in which there is no background RF signal energy.

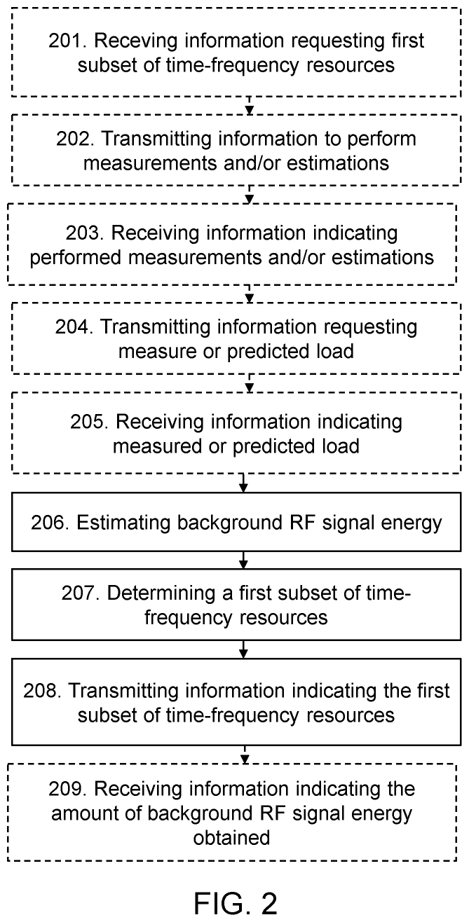

Examples of embodiments of a method performed by a first network node 110 for enabling a first wireless device 121 to obtain background Radio Frequency, RF, signal energy from background RF signals provided by the first network node 110 and/or at least one second network node 111-113 in a wireless communications network 100 on a set of time-frequency resources, will now be described with reference to the flowchart depicted in FIG. 2. FIG. 2 is an illustrated example of actions or operations which may be taken by the first network node 110 in the wireless communication network 100. The method may comprise the following actions.

### Action 201

Optionally, the first network node 110 may receive, from the first wireless device 121, information requesting a first subset of the set of time-frequency resources to use for obtaining background RF signal energy. This means that the first network node 110 may be informed by the first wireless device 121 that it has detected a need to harvest RF signal energy in order to, e.g. increase its battery energy level. In other words, the first network node 110 may here receive an indication from the first wireless device 121 that the first wireless device 121 has a low energy level, or expect that it will soon run out of energy, and therefore need to harvest RF signal energy.

In some embodiments, the information requesting a first subset of the set of time-frequency resources may comprise information indicating one or more capabilities of the first wireless device 121 for obtaining background RF energy from background RF signals received on the set of time-frequency resources. This means, for example, that the first network node 110 may be informed about the capabilities of the first wireless device 121 to harvest RF signal energy on a certain time-frequency resources, for example, the supported RF carriers by the first wireless device 121. Here, the first wireless device 121 may also include the number of RF carriers that the first wireless device 121 may support simultaneously while harvesting RF signal energy. In some embodiments, the first wireless device 121 may also include one or more preferred frequencies to use for harvesting RF signal energy. The latter may, for example, be where the first wireless device 121 conventionally has the most efficient energy harvesting.

### Action 202

According some embodiments, the first network node 110 may transmit, to the first wireless device 121, information indicating that background RF signal quality measurements on each time-frequency resource in the set of time-frequency resources, and/or background RF signal quality estimations on each time-frequency resource in the set of time-frequency resources, is to be performed. This means, for example, that the first network node 110 may send a request to the first wireless device 121 to provide signal quality measurement on the set of time-frequency resources. Optionally, the first network node 110 may, for example, configure the first wireless device 121 to perform inter-frequency measurements for the RF carriers intended for energy harvesting. Here, it should be noted that the first network node 110 may generally use reference signals to obtain measurements performed by the first wireless device 121 on beams transmitted by the first network node 110, for example, to assess the signal quality of the beams. In general, the reference signals transmitted by the first network node 110 to the first wireless device 121 may comprise at least one of: a Chanel State Information-Reference Signal (CSI-RS), a Synchronization Signal Block (SSB), a Primary Synchronization Signal (PSS), a Secondary Synchronization Signal (SSS), a Common Reference Signal (CRS), a Reference Signal Received Power (RSRP) and a Reference Signal Received Quality (RSRQ). In particular, this means that the first wireless device 121 may assess beam qualities, for example, via measurements on the SSB. This may correspond to a Synchronization Signal/Physical Broadcast Channel (PBCH) block in a 5G/NR wireless communications network. Alternatively, the first wireless device 121 may also assess beam qualities, for example, via measurements on the CSI-RS resources in a 4G/LTE or 5G/NR wireless communications network. According to another alternative, the first wireless device 121 may also evaluate the signal quality using RSRP and/or RSRQ signals. In a further alternative, the first wireless device 121 may predict the signal qualities by being configured with and using a Secondary Carrier Prediction (SCP) model (as described in, for example, the patent application US2019357057 A1 or “Predicting strongest cell on secondary carrier using primary carrier data”, H.Rydén et al, 2018 IEEE Wireless Communications and Networking Conference Workshops (WCNCW), ISBN 978-1-5386-1155-5).

### Action 203

After the transmission in Action 202, the first network node 110 may receive, from the first wireless device 121, information indicating background RF signal quality measurements performed on each time-frequency resource in the set of time-frequency resources, and/or background RF signal quality estimations on each time-frequency resource in the set of time-frequency resources. This means that the first network node 110 may be provided with background RF signal quality measurements on the set of time-frequency resources by the first wireless device 121, e.g. in response to the request in Action 202. The background RF signal quality may be measured by the first wireless device 121 on signals associated with for example, SSB-beams, CSI-RS, PDSCH, RSRP, RSRQ, etc.

### Action 204

According to a further option, the first network node 110 may transmit, to the at least one second network node 111-113, information requesting measured or predicted RF signal load at the least one second network node 111-113 on each time-frequency resource in the set of time-frequency resources. This means that the first network node 110 may send a request to the at least one second network node 111-113 in order to understand the data traffic from its neighboring nodes in addition to its own serving data traffic. The first network node 121 may thus request forecasted data traffic (which may be obtained using a prediction model with, for example, historical traffic information as input, located in the first network node 121, such as described in for example “Cellular Traffic Prediction with Recurrent Neural Network”, Shan Jaffry, DGUT-CNAM Institute, 5 mars, 2020) or actual data traffic from the at least one second network node 111-113. This may, for example, be performed over the XN interface and also be based on the measured or predicted signal qualities described in Action 202. Here, it should be noted that the selection of the at least one second network node 111-113 may, for example, be based on whether or not a measured reference signal from each of the at least one second network node 111-113 is above a certain determined threshold value. Optionally, the selection of the at least one second network node 111-113 may also, for example, be based on SCP. Here, the at least one second network node 111-113 which cell/cells has a predicted coverage above a certain determine threshold value may be selected.

According to one example, the RF signal load may, for example, comprise the predicted number or actual number of connected wireless devices to the at least one second network node 111-113 in respective cell 116, 117, 118. The first network node 110 may also request the predicted RF signal load in relation to a certain beam or time-frequency resource. For example, the first network node 110 may request the RF signal load in respect to a certain measured CSI-RS or predicted CSI-RS to be received/harvested by the first wireless device 121. The RF signal load may further comprise, the time-frequency resources, such as PRBs or subframes, where the downlink PDSCH resource utilization is above or below a certain determined threshold value configured in the first network node 110.

In some embodiments, the first network node 110 may requests the at least one second network node 111-113 to provide its estimated energy transfer to a certain location directly, preferably the location of the first wireless device 121. Here, the location may, for example, comprise one or more of a radio location in the form of a certain radio fingerprint, such as a set of signal quality estimates on one or more frequencies, or a geolocation estimate. Hence, according to some embodiments, the transmitted information may comprise the location of the first wireless device 121 in the wireless communications network 100.

In some embodiments, the first wireless device 121 may be configured to monitor the uplink channel instead of the downlink channel. In this case, the first network node 110 may be request the at least one second network node 111-113 to provide an estimate if first wireless device 121 could harvest the energy transmitted by another wireless device, such as the third and fourth wireless device 123, 124, served by the at least one second network node 111-113. The radio or geolocation may here be used as input for the at least one second network node 111-113 to determine if it would be useful for the first wireless device 121 to listen to a certain wireless device, such as the third and fourth wireless device 123, 124, that is in the vicinity of the first wireless device 121.

According to some embodiments, the first network node 110 may also request one or more of the at least one second network node 111-113 to transmit some RF signal energy towards the first wireless device 121. Alternatively, the first network node 110 may also request one or more of the at least one second network node 111-113 to adapt its beamforming decision to focus the RF signal energy also towards the first wireless device 121. This would then lead to less bitrate for the wireless devices connected to the one or more of the at least one second network node 111-113, but improve the background RF signal energy harvesting for the first wireless device 121. This may, for example, be advantageous in case the first wireless device 121 needs to charge its battery fast for a latency critical applications.

### Action 205

After the transmission in Action 202, the first network node 110 may receive, from the at least one second network node 111-113, information indicating measured or predicted RF signal load at the least one second network node 111-113 on each time-frequency resource in the set of time-frequency resources. This means that the first network node 110 may be provided with the measured or predicted RF signal load requested from the at the least one second network node 111-113 in Action 204. In some embodiments, the received information may comprise information indicating an estimated RF signal energy provided by the least one second network node 111-113 on each time-frequency resource in the set of time-frequency resources for the location of the first wireless device 121 in the wireless communications network 100. This means that the first network node 110 may be provided with the measured or predicted RF signal load requested from the at the least one second network node 111-113 in Action 204 based on the location of the first wireless device 121.

### Action 206

The first network node 110 estimates a background RF signal energy available to the first wireless device 121 in each time-frequency resource in the set of time-frequency resources. This means that the network node 110 may estimate the total background RF signal energy that may be harvested by the first wireless device 121 in the time-frequency resources. Here, according to some embodiments, the first network node 110 may perform the estimation by aggregating an estimated background RF signal energy from each of the first network node 110 and/or the at least one second network node 111-113 for each time-frequency resource in the set of time-frequency resources. This means that the first network node 110 may estimate the total background RF signal energy by aggregating or combining the estimated background RF signal energy for each network node, i.e. the first network node 110 and/or the at least one second network node 111-113, transmitting in the set of time-frequency resources.

According to one example, the first network node 110 may determine energy harvesting estimates for the first wireless device 121 for each time-frequency resource by combining radio signal measurements S, such as RSRP measurements, with the data traffic T from each of the at least one second network node 111-113 in each respective cell, c, 116, 117, 118 on a time-frequency resource r. The energy harvesting estimates may then, for example, be determined according to Eq. 1:

$${E}_{r} = {\sum }_{c ∈ C} {T}_{c} {S}_{c} , \qquad ( Eq . 1 )$$

According to another example, the first network node 110 may determine energy harvesting estimates for the first wireless device 121 by predicting the background RF signals using SCP, wherein the background RF signals is associated with a probability of coverage, p_{c}, by each of the at least one second network node 111-113 in each respective cell, c, 116, 117, 118 on a certain frequency, f, and combining it with a data traffic estimate, t_{c}, indicative of the expected DL resource utilization in each respective cell, c, 116, 117, 118, on the frequency, f. Here, the data traffic estimate t_{c}. may reflect the expected DL resource utilization within the next T seconds. The energy harvesting estimates may then, for example, be determined according to Eq. 2:

$${E}_{f} = {\sum }_{c ∈ C} {t}_{c} {p}_{c} , \qquad ( Eq . 2 )$$

According to a further example, the first network node 110 may determine energy harvesting estimates for the first wireless device 121 for each time-frequency resource based on an expected signal quality value using SCP or the actual measured signal quality value, such as RSRP/RSRP/SINR. The energy harvesting estimates may then, for example, be determined according to Eq. 3:

$${F}_{f} = {\sum }_{c ∈ C} {t}_{c} {\hat{RSRP}}_{c} , \qquad ( Eq . 3 )$$

According to a further example, the first network node 110 may determine energy harvesting estimates for the first wireless device 121 for a certain frequency, f, by combining the background RF signal quality, signalQuality_{c}, measured by the first wireless device 121 for each of the at least one second network node 111-113 in each respective cell, c, 116, 117, 118, with a predicted or historical DL resource utilization, traffic_{c}, in each respective cell, c, 116, 117, 118. The energy harvesting estimates may then, for example, be determined according to Eq. 4:

$${E}_{f} = {\sum }_{c ∈ C} {traffic}_{c} \times {signalQuality}_{c} , \qquad ( Eq . 4 )$$

As described in the examples above, the first network node 110 may, according to some embodiments, perform the estimation based on information indicating background RF signal quality measurements performed on each time-frequency resource in the set of time-frequency resources, and/or background RF signal quality estimations for each time-frequency resource in the set of time-frequency resources. Here, the background RF signal quality may be provided by signal quality measurements on the set of time-frequency resources received from the first wireless device 121 in Action 203. As also described in the examples above, the first network node 110 may also, according to some embodiments, perform the estimation based on one or more of: predicted signal quality values for specific reference signals performed by the first network node 110 for the first wireless device 121; predicted signal quality values for specific reference signals performed by the first wireless device 121; and signal measurements performed by the first network node 110 on Uplink, UL, signal transmissions from the first wireless device 121. This means that the first network node 110 may estimate the background RF signal energy available to the first wireless device 121 in each time-frequency resource in the set of time-frequency resources based on predicted background RF signal qualities for the first wireless device 121 by using, for example, SCP with source carrier measurements, forecasted background RF signal quality values for a certain reference signal (described in patent application WO2020226542), or measured signals by the first network node 110 on uplink transmission signal, such as Sounding Reference Signals (SRS) or Physical Uplink Shared Channel (PUSCH).

For example, according to some embodiments, the first network node 110 may predict the background RF signal qualities using a Secondary Carrier Prediction (SCP) model (as referenced above). Here, the SCP model is used to predict other carriers/RATs radio conditions based on measurements that are readily available or acquirable on a source carrier. This may provide a radio location of the first wireless device 121 and enable cell coverage probabilities for the first wireless device 121 on another frequency. Also, the expected background RF signal quality characteristics for each carrier may comprise a probability of the first wireless device 121 having coverage on one specific cell on specific carrier frequency, or the RSRP estimation or measurement on a candidate cell. One way of obtaining this coverage probability is to first estimate the coverage probability for each cell by dividing the serving cell, i.e. the cell 115 of the first network node 110, into smaller areas; this may be performed by using, e.g. Timing Advance, TA, or Precoding Matrix Indicator, PMI. Next, the coverage probability of the first wireless device 121 may be determined by using a capacity cell overlap for each of the smaller areas. Consequently, the coverage probability of the first wireless device 121 will depend on the location of the first wireless device 121 within the serving cell. Another way of obtaining this coverage probability on a specific carrier frequency is based the geographical location of the first wireless device 121. Here, it may be expected that a wireless device in vicinity of a capacity cell has a higher probability of coverage than a wireless device located far away. The location of the first wireless device 121 may, for example, be estimated by an LTE or NR positioning procedure, such as Assisted Global Navigation Satellite System, A-GNSS/A-GPS, Observation Arrival Time Difference, OTDOA, Uplink Time Difference of Arrival, UTDOA, and Enhanced/Advanced Cell Identity, Ecell-ID/E-CID.

As further described in the examples above, the first network node 110 may also, according to some embodiments, the first network node 110 may perform the estimation based on information indicating measured or predicted RF signal load at the least one second network node 111-113 on each time-frequency resource in the set of time-frequency resources. Here, the measured or predicted RF signal loads may be the measured or predicted RF signal loads received from at the least one second network node 111-113 in Action 205.

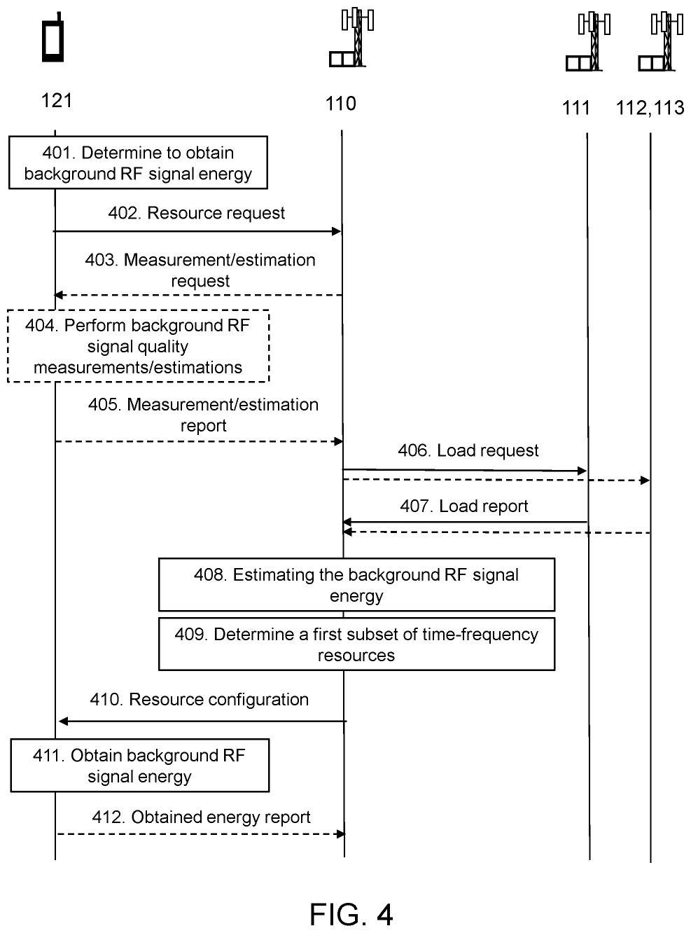

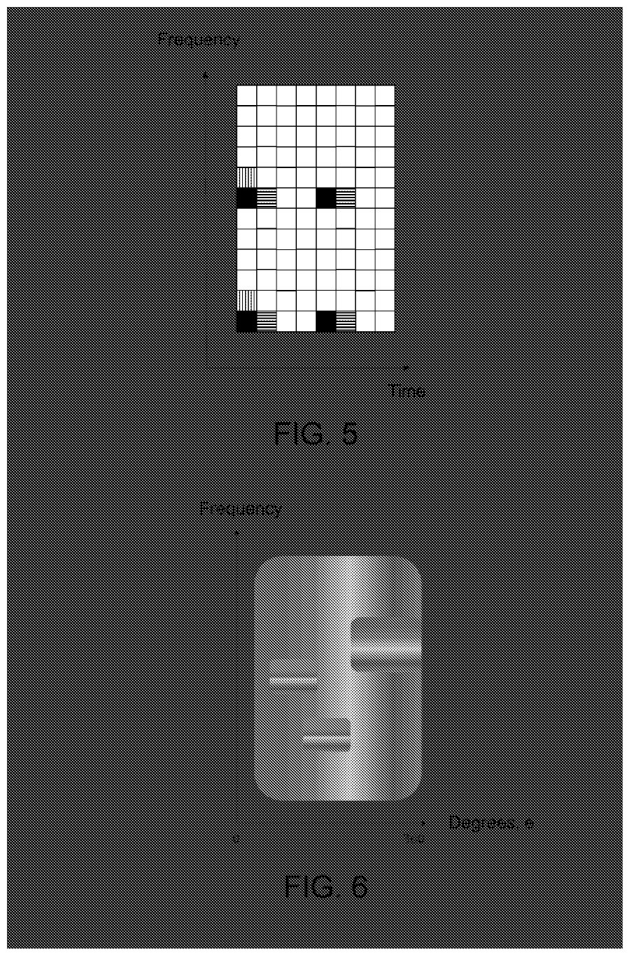

In some embodiments, the first network node 110 may perform the estimation by probing the background RF signal energy from background RF signals transmitted by the at least one network node 111-113 on each time-frequency resource in the set of time-frequency resources. This means that, according to some embodiments, the first network node 110 may probe the frequency spectrum to estimate the available background RF signal energy for the first wireless device 121 on each RF carrier. Here, the first network node 110 may sense the background RF signal energy level on each RF carrier at certain time instances. The type of probing may be performed on a regular basis, such as sensing the frequency spectrum every T second, that is, periodically over uniform time-frequency intervals. Optionally, the probing may be adaptive in which case the sensing intervals may be adapted based on transmission characteristics or conditions, such as data traffic type, the mobility level of the first wireless device 121, time of the day, etc. According to some embodiments, the sensed background RF signal energy levels from the probed spectrum may then be compared to a determined threshold values to indicate whether or not the sensed background RF signal energy levels are above the minimum background RF signal energy that is sufficient for the first wireless device 121 to perform background RF signal energy harvesting. If the result of the probing is larger than the threshold the corresponding carrier can be considered to be scheduled for the energy harvesting. The probing measurements on the frequency spectrum, or set of time-frequency resources, are described in more detail below with reference to FIGS. 5-6.

In some embodiments, the probing may, for example, enable training data to be obtained and used, for example, by a Supervised Learning (SL) algorithm, to train a Machine Learning (ML) model, such as an artificial neural network (ANN), etc. The ML model may, for example, be built based on the probing data collected for a set of time-frequency resources as input, while available background RF signal energy levels for the set of time-frequency resources may be used as a desired output. This model may then be implemented in and used by the first network node 110 to predict or estimate the available background RF signal energy level over other time-frequency resources for other wireless devices. Hence, according to some embodiments, the first network node 110 may comprise a machine learning model that is trained to estimate the background RF signal energy from each of the first network node 110 and/or the at least one second network node 111-113 on other time-frequency resources than the set of time-frequency resources based on the probed RF signal energy from background RF signals transmitted by the at least one network node 111-113 on each time-frequency resource in the set of time-frequency resources.

### Action 207

After the estimation in Action 206, the first network node 110 determines a first subset of the set of time-frequency resources that the wireless device 121 is to use for obtaining background RF signal energy based on the estimated background RF signal energy. This means that the first network node 110 is able to configure in which time-frequency resources the first wireless device 121 should perform background RF signal energy harvesting; that is, e.g. based on the estimated background RF signal energy for a plurality of time-frequency resources. This may, for example, be performed by the first network node 110 by selecting time-frequency resources that may provide the maximum amount of estimated background RF signal energy.

In some embodiments, the first subset of the set of time-frequency resources is estimated to comprise a higher level of background RF signal energy than at least one second subset of the set of time-frequency resources and/or the level of background RF signal energy in the first subset of the set of time-frequency resources is above a determined threshold value. This means, for example, that the first network node 100 may, after determining the energy harvesting estimates for the first wireless device 121 as described in Action 206, configure the first wireless device 121 to harvest background RF signal energy in a time-frequency resource only if it is above a determined threshold value. In some cases, the first wireless device 121 may not be capable to harvest background RF signal energy in two time-frequency resources simultaneously, such as in two different RF carriers; as the first network node 110 may be informed about in the received capabilities of the first wireless device 121 in Action 201. In this case, the first network node 110 may, according to some embodiments, select the time-frequency resource, e.g. RF carrier, that provides the maximum estimated background RF signal energy. Here, it should also be noted that the first wireless device 121 may also support background RF signal energy harvesting on multiple receiver chains, that is, the first wireless device 121 may be configured with N receiver chains and thus be configured to harvest on the N carriers with highest expected background RF signal energy to be harvested.

In some embodiments, wherein the information requesting a first subset of the set of time-frequency resources in Action 201 comprise information indicating one or more capabilities of the first wireless device 121 for obtaining background RF energy from background RF signals received on the set of time-frequency resources, the first subset of the set of time-frequency resources may be determined based on information indicating one or more capabilities of the first wireless device 121 for obtaining background RF signal energy from background RF signals received on the set of time-frequency resources.

It should also be noted that the set of time-frequency resources may, for example, be defined by the RF carrier frequency, and more specifically, by one or more of: an entire RF carrier bandwidth or frequency (e.g. a wideband), a determined sub-band of an RF carrier (e.g. per PRB or PRB pair, per groups of PRBs, etc.), a Resource Element (RE) within a sub-band), one or more radio frames, sub-frames, or Time Transmission Intervals, TTIs, a determined time-duration for energy harvesting, and a time-frequency resource, e.g. RE, in which there is a reference signal, e.g. SSB or CSI-RS, or data, e.g. PDSCH, transmitted.

### Action 208

Following the determination in Action 207, the first network node 110 transmits information indicating the determined first subset of the time-frequency resources to the first wireless device 121. This means that the first network node 110 may inform the first wireless device 121 about the most suitable or optimal time-frequency resources for the first wireless device 121 to perform background RF signal energy harvesting on.

In addition to indicating the first subset of the set of time-frequency resources, e.g. a specific RF carrier frequency, the information may according to some embodiments further comprise a time-duration over which the first wireless device 121 may harvest background RF signal energy on the first subset of the set of time-frequency resources. This may, for example, be based on the measured or predicted RF signal load information received from the at least one second network node 111-113 for the determined first subset of the time-frequency resources. Alternatively, in some embodiments, the information may further indicate a certain time-frequency pattern when the first wireless device 121 should harvest background RF signal energy on the first subset of the set of time-frequency resources. This may, for example, be based on the information indicating that the determined first subset of the time-frequency resources has periodic traffic, e.g. the measured or predicted RF signal load information received from the at least one second network node 111-113 for the determined first subset of the time-frequency resources. According to another alternative, the information may also comprise an indication or configuration that the first wireless device 121 is to perform background RF signal energy harvesting on the first subset of the set of time-frequency resources until the first wireless device 121 has obtained a given amount of energy.

According to a further option, the information may comprise energy harvesting estimates for the first wireless device 121 on the set of time-frequency resources. This would enable the first wireless device 121 to select the first subset of the set of time-frequency resources from the set of time-frequency resources itself. In yet another embodiments, the information may comprise data traffic information from the at least one second network node 111-113 on the set of time-frequency resources, in order for the first wireless device 121 to predict the background RF signal energy on the set of time-frequency resources itself.

### Action 209

Optionally, the first network node 110 may receive, from the first wireless device 121, information indicating the amount of background RF signal energy obtained by the first wireless device 121 from the background RF signals on the determined first subset of the set of time-frequency resources. This means that the first network node 110 may obtain feedback from the first wireless device 121 indicating its harvested energy on the set of time-frequency resources. The feedback may, for example, comprise the amount of energy harvested on the determined first subset of time-frequency resources configured by the first network node 110, e.g. the first wireless device 121 may report an energy amount between 0-100, where 100 means that the first wireless device 121 could harvest the maximum amount of energy. Alternatively, the feedback may, for example, comprise the time it took to reach a desired energy level by harvesting on the determined first subset of time-frequency resources configured by the first network node 110, or comprise an absolute energy measure, such as watthours.

This feedback may, for example, enable training data to be obtained and used, for example, by a Supervised Learning (SL) algorithm, to train a Machine Learning (ML) model, such as an artificial neural network (ANN), etc. The ML model may, for example, be built based on the estimated background RF signal energy from each of the first network node 110 and/or the at least one second network node 111-113 in each time-frequency resource in the set of time-frequency resources as input, while the feedback information indicating the amount of background RF signal energy obtained by the first wireless device 121 from the background RF signals on the determined first subset of the set of time-frequency resources may be used as a desired output. Other inputs may, for example, be the background RF signal quality measurements performed on each time-frequency resource in the set of time-frequency resources, the background RF signal quality estimations on each time-frequency resource in the set of time-frequency resources, predicted signal quality values for specific reference signals performed by the first network node 110 for the first wireless device 121, predicted signal quality values for specific reference signals performed by the first wireless device 121, and signal measurements performed by the first network node 110 on Uplink, UL, signal transmissions from the first wireless device 121, etc. Here, according to one example, the ML model may be built based on a mapping f(X) to y, wherein the output y may comprise the background RF signal energy estimate for a certain time-frequency resource (or an index of which time-frequency resource that is estimated to provide the highest amount of background RF signal energy) and the input X may comprise one or more of the available background RF signal energy information available to the first network node 110, such as, the RF signal loads of the at least one second network node 111-113, background RF signal qualities, probing data, etc.

Hence, according to some embodiments, the first network node 110 may comprise a machine learning model that is trained to estimate how much background RF signal energy that could be provided to the first wireless device 121 in the one or more subsets in the set of time-frequency resources based on: the estimated background RF signal energy from each of the first network node 110 and/or the at least one second network node 111-113 in each time-frequency resource in the set of time-frequency resources. Here, it should be noted that the estimation may also be based on other inputs, such as the background RF signal quality measurements performed on each time-frequency resource in the set of time-frequency resources, the background RF signal quality estimations on each time-frequency resource in the set of time-frequency resources, predicted signal quality values for specific reference signals performed by the first network node 110 for the first wireless device 121, predicted signal quality values for specific reference signals performed by the first wireless device 121, and signal measurements performed by the first network node 110 on Uplink, UL, signal transmissions from the first wireless device 121, etc.

Here, according to some embodiments, the first network node 110 may be configured to subsequently use the estimated one or more subsets in the set of time-frequency resources when determining the first subset of the set of time-frequency resources for other wireless devices in the wireless communications network 100. As described above, the feedback from the first wireless device 121 may enables the first network node 110 to use a data driven approach to, for example, learn the best RF carrier/frequency to harvest on when another wireless devices, such as the second wireless device 122, experiencing a similar situation as the first wireless device 121, e.g. in terms of signal qualities, load information and/or probing information, etc., and take an improved decision. For example, Reinforcement Learning (RL) techniques may be used in order to improve frequency selection for next set of energy harvesting wireless devices.

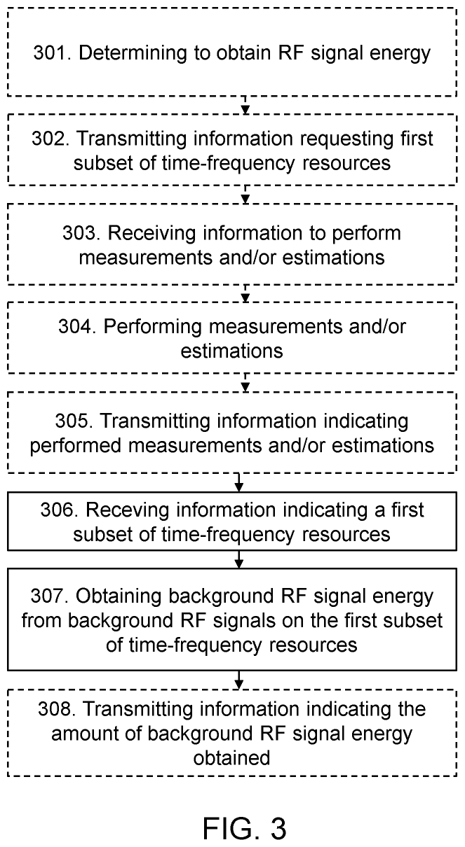

Examples of embodiments of a method performed by a first wireless device 121 for obtaining Radio Frequency, RF, signal energy from background RF signals provided by a first network node 110 and/or at least one second network node 111-113 in a wireless communications network 100 on a set of time-frequency resources, will now be described with reference to the flowchart depicted in FIG. 3. FIG. 3 is an illustrated example of actions or operations which may be taken by the first wireless device 121 in the wireless communication network 100. The method may comprise the following actions.

### Action 301

Optionally, the first wireless device 121 may determine that the first wireless device 121 is to obtain background RF signal energy from received background RF signals. This means that the first wireless device 121 may detect that there is a need for the first wireless device 121 to perform energy harvesting. For example, a battery power level in the first wireless device 121 may be below a determined threshold value.

In some embodiments, the first wireless device 121 may here also probe the background RF signal energy levels of the set of time-frequency resources in order to estimate the total background RF signal energy in the set of time-frequency resources. This means that the first wireless device 121 may probe the frequency spectrum to estimate the available background RF signal energy for the first wireless device 121 on each RF carrier. This may be performed in order to determine whether or not it should attempt to obtain background RF signal energy from received background RF signals. Here, after the probing, the first wireless device 121 may determine that the first wireless device 121 is to obtain background RF signal energy from RF signals on the set of time-frequency resources if the estimated total background RF signal energy on the set of time-frequency resources is above a determined threshold value. This means that if the background RF signal energy probing indicate that the background RF signal energy level on the set of time-frequency resources is above a certain threshold value, then the first wireless device 121 should attempt obtain background RF signal energy from received background RF signals. The probing measurements on the frequency spectrum, or set of time-frequency resources, may be performed in a similar manner as described for the first network node 110 above and is further described in more detail below with reference to FIGS. 5-6. Also, in this case, according to some embodiments, the first wireless device 121 may comprise a machine learning model that is trained to estimate the total background RF signal energy on the set of time-frequency resources based on the probed background RF signal energy levels for the set of time-frequency resources. This means ta similar trained machine learning model described above with reference to the probing of the frequency spectrum performed by the first network node 110 in Action 206 also may be implemented and used in the first wireless device 121.

According to another option, the first wireless device 121 may in some embodiments also perform radio signal quality predictions in order to estimate the total background RF signal energy in the set of time-frequency resources. This means, for example, that the first wireless device 121 may predict the signal qualities by being configured with and using a Secondary Carrier Prediction (SCP) model (as referenced above). Here, after the estimation, the first wireless device 121 may determine that the first wireless device 121 is to obtain background RF signal energy from RF signals on the set of time-frequency resources if the estimated total background RF signal energy on the set of time-frequency resources is above a determined threshold value. This means that if the background RF signal energy predictions indicate that the background RF signal energy level on the set of time-frequency resources is above a certain threshold value, then the first wireless device 121 should attempt obtain background RF signal energy from received background RF signals.

### Action 302

After the determination in Action 301, the first wireless device 121 may transmit information requesting a first subset of the set of time-frequency resources to use for obtaining background RF signal energy. This means that the first wireless device 121 may inform the first network node 110 that it has detected a need to harvest RF signal energy in order to, e.g. increase its battery power level. In other words, the first wireless device 121 may here indicate to the first network node 110 that it has a low energy level, or expect that it will soon run out of energy, and therefore need to harvest RF signal energy.

In some embodiments, the information requesting a first subset of the set of time-frequency resources may further comprise information indicating one or more capabilities of the first wireless device 121 to obtain background RF energy from background RF signals received on the set of time-frequency resources. This means, for example, that the first wireless device 121 may also include its capabilities in harvesting RF signal energy on a certain time-frequency resources, for example, its supported RF carriers. Here, the first wireless device 121 may also include the number of RF carriers that the first wireless device 121 may support simultaneously while harvesting RF signal energy. In some embodiments, the first wireless device 121 may also include one or more preferred frequencies to use for harvesting RF signal energy. The latter may, for example, be where the first wireless device 121 conventionally has the most efficient energy harvesting.

### Action 303

According to another option, the first wireless device 121 may receive information indicating that background RF signal quality measurements on each time-frequency resource in the set of time-frequency resources, and/or an estimated background RF signal quality on each time-frequency resource in the set of time-frequency resources, is to be performed. This means, for example, that the first wireless device 121 may receive a request from the first network node 110 to provide signal quality measurement on the set of time-frequency resources. In other words, the first wireless device 121 may be configured by the first network node 110 to provide signal quality measurement on the set of time-frequency resources.

### Action 304

After receiving the information in Action 303, the first wireless device 121 may perform background RF signal quality measurements on each time-frequency resource in the set of time-frequency resources, and/or background RF signal quality estimations on each time-frequency resource in the set of time-frequency resources. This means, for example, that the first wireless device 121 may be configured by the first network node 110 to perform inter-frequency measurements on the RF carriers intended for energy harvesting. The inter-frequency measurements may be performed on certain reference signals, such as a Chanel State Information-Reference Signal (CSI-RS), a Synchronization Signal Block (SSB), a Primary Synchronization Signal (PSS), a Secondary Synchronization Signal (SSS), a Common Reference Signal (CRS), a Reference Signal Received Power (RSRP) and a Reference Signal Received Quality (RSRQ). In other words, the background RF signal quality may be measured by the first wireless device 121 on signals associated with certain reference signal, such as SSB-beams, CSI-RS, PDSCH, RSRP, RSRQ, etc. In particular, this means that the first wireless device 121 may assess beam qualities, for example, via measurements on the SSB. This may correspond to a Synchronization Signal/Physical Broadcast Channel (PBCH) block in a 5G/NR wireless communications network. Alternatively, the first wireless device 121 may also assess beam qualities, for example, via measurements on the CSI-RS resources in a 4G/LTE or 5G/NR wireless communications network. According to another alternative, the first wireless device 121 may also evaluate the background RF signal quality using RSRP and/or RSRQ signals. In a further alternative, the first wireless device 121 may predict the background RF signal qualities by being configured with and using a Secondary Carrier Prediction (SCP) model (as referenced above).

In some embodiments, the background RF signal quality measurements or estimations may, for example, enable training data to be obtained and used, for example, by a Supervised Learning (SL) algorithm, to train a Machine Learning (ML) model, such as an artificial neural network (ANN), etc. The ML model may, for example, be built based on collected data of previously performed background RF signal quality measurements or estimations on each time-frequency resource in the set of time-frequency resources as input, while the actual background RF signal energy levels on the set of time-frequency resources may be used as a desired output. This model may then be implemented in and used by the first wireless device 121 to estimate the available background RF signal energy level over other time-frequency resources. Hence, according to some embodiments, the first wireless device 121 may comprise a machine learning model is trained to estimate the background RF signal quality on each time-frequency resource in the set of time-frequency resources based on previously performed background RF signal quality measurements on each time-frequency resource in the set of time-frequency resources.

### Action 305

Optionally, after performing the measurements and/or estimations in Action 304, the first wireless device 121 may transmit information indicating performed background RF signal quality measurements on each time-frequency resource in the set of time-frequency resources, and/or an estimated background RF signal quality on each time-frequency resource in the set of time-frequency resources. This means that the first wireless device 121 may provide the first network node 110 with background RF signal quality measurements on the set of time-frequency resources, e.g. in response to the received request in Action 303.

### Action 306

The first wireless device 121 receives information indicating a first subset of the set of time-frequency resources that the first wireless device 121 is to use for obtaining RF signal energy. This means, for example, that the first wireless device 121 may receive an indication from the first network node 110 of which set of time-frequency resources to use for background RF signal energy harvesting. In other words, the first wireless device 121 may be configured by the first network node 110 to use a determined set of time-frequency resources for background RF signal energy harvesting.

In addition to indicating the first subset of the set of time-frequency resources, e.g. a specific RF carrier frequency, the information may according to some embodiments further comprise a time-duration over which the first wireless device 121 may harvest background RF signal energy on the first subset of the set of time-frequency resources. Alternatively, in some embodiments, the information may further indicate a certain time-frequency pattern when the first wireless device 121 should harvest background RF signal energy on the first subset of the set of time-frequency resources. According to another alternative, the information may also comprise an indication or configuration that the first wireless device 121 is to perform background RF signal energy harvesting on the first subset of the set of time-frequency resources until the first wireless device 121 has obtained a given amount of energy.

According to a further option, the information may comprise energy harvesting estimates for the first wireless device 121 on the set of time-frequency resources. This would enable the first wireless device 121 to select the first subset of the set of time-frequency resources from the set of time-frequency resources itself. In yet another embodiments, the information may comprise data traffic information from the at least one second network node 111-113 on the set of time-frequency resources, in order for the first wireless device 121 to predict the background RF signal energy on the set of time-frequency resources itself. This may then be performed in a similar manner as described above for the first network node 110 in Action 206.

### Action 307

After receiving the information in Action 306, the first wireless device 121 obtains RF signal energy from background RF signals received on the first subset of the set of time-frequency resources. This means, for example, that the first wireless device 121 may harvest background RF signal energy on the first subset of the set of time-frequency resources, e.g. a specific RF carrier, in accordance with the resource configuration received from the first network node 110 in Action 306.

### Action 308

After obtaining the background RF signal energy in Action 307, the first wireless device 121 may transmit information indicating the amount of background RF signal energy obtained by the first wireless device 121 from the background RF signals on the first subset of the set of time-frequency resources. This means that the first wireless device 121 may send information to the first network node 110 reporting the amount of obtained or harvested background RF signal energy.

It should also be noted that, according to some embodiments, the set of time-frequency resources may be downlink, DL, or uplink, UL, time-frequency resources. This means that the first wireless device 121 may, according to some embodiments, monitor also the UL in addition to the DL, or the UL instead of the DL. Hence, in this case, the first network node 110 may request the at least one second network node 111-113 to provide an estimate if the first wireless device 121 may harvest background RF signal energy transmitted by another wireless device served by the at least one second network node 111-113, such as the third and fourth wireless device 123, 124. Here, the first network node 110 may also incorporate or use the radio or geolocation of the first wireless device 121 as input when determining if it would be useful for the wireless device 121 to listen to another wireless device in its vicinity.

Furthermore, in some embodiments, the background RF signals are RF signals transmitted on the set of time-frequency resources that are not specifically dedicated for transmissions to or from the first wireless device 121.

FIG. 4 shows a signalling diagram illustrating embodiments of the first network node 110 and the first wireless device 121 in a wireless communications network 100.

Action 401. The first wireless device 121 may start by determining to obtain or harvest background RF signal energy, that is, the first wireless device 121 may detect a need in the first wireless device 121 to harvest energy from background RF signals in the wireless communications network 100. For example, the battery power in a battery in the wireless device 121 may be running low.

Action 402. The first wireless device 121 may then send a resource request to the first network node 110, i.e. its serving network node, requesting the first network node 110 to send information about a first subset of a set of time-frequency resources in which the first wireless device 121 should perform background RF signal energy harvesting.

Action 403. Optionally, in response to the resource request from the first wireless device 121 in Action 402, the first network node 110 may send a measurement or estimation request back to the first wireless device 121. The measurement or estimation request configuring the wireless device 121 to perform background RF signal measurements or estimations on the set of time-frequency resources.

Action 404. Upon receiving the measurement or estimation request from the first network node 110, the first wireless device 121 may perform background RF signal measurements or estimations on the set of time-frequency resources.

Action 405. The first wireless device 121 may then transmit the result of the performed background RF signal measurements or estimations on the set of time-frequency resources to the first network node 110 in a measurements or estimations report.

Action 406. In response to the resource request from the first wireless device 121 in Action 402, the first network node 121 sends a RF load request to the at least one second network nodes 111, 112, 113. The RF load request may request the estimated data traffic between the at least one second network nodes 111, 112, 113 and it's served wireless devices, e.g. the third and fourth wireless device 123, 124, on the set of time-frequency resources.

Action 407. In response to the RF load request, the first network node 110 may receive RF load reports from the at least one second network nodes 111, 112, 113. The RF load request may comprise the estimated data traffic between the at least one second network nodes 111, 112, 113 and it's served wireless devices, e.g. the third and fourth wireless device 123, 124, on the set of time-frequency resources by the at least one second network nodes 111, 112, 113, respectively.

Action 408. The first network node 110 may then estimate the background RF signal energy that is available to the first wireless device 121 on the set of time-frequency resources. This may, for example, be based on the performed background RF signal measurements or estimations on the set of time-frequency resources by the wireless device 121 received in Action 405, and/or on the estimated data traffic between the at least one second network nodes 111, 112, 113 and it's served wireless devices, e.g. the third and fourth wireless device 123, 124, on the set of time-frequency resources received in Action 407.

Action 409. The first network node 110 may then determine the most suitable of the time-frequency resources in the set of time-frequency resources, i.e. the first subset of time-frequency resources, for the first wireless device 121 to perform background RF signal energy harvesting on based on the estimated background RF signal energy that is available to the first wireless device 121 on the set of time-frequency resources.

Action 410. The first network node 110 may then transmit a resource configuration message comprising information indicating the determined first subset of time-frequency resources to the first wireless device 121.

Action 411. In response to receiving the determined first subset of time-frequency resources from the first network node 110, the first wireless device 121 may start to obtain or harvest background RF signal energy from RF signal transmitted on the first subset of time-frequency resources in the wireless communication network 100.

Action 412. Optionally, the first wireless device 121 may transmit an energy report to the first network node 110 to indicate the obtained or harvested background RF signal energy on the first subset of time-frequency resources.

The embodiments presented herein may also be described by the following illustrative example. In this scenario, the first network node 110 handles a first cell 115 and a second cell 116 is handled by a second network node 111, as shown in FIG. 1. The first wireless device 121 being served in the first cell 115 on a RF carrier 0 may intend to harvest background RF signal energy. The first wireless device 121 may then report a capability in supporting RF carrier 1 and 2 for background RF signal energy harvesting to the first network node 110. The first network node 110 may then request the first wireless device 121 to provide background RF signal quality measurements on the RF carrier 1 and 2. Here, the first wireless device 121 may report the background RF signal quality measurements as shown below in Table 1. In Table 1, the first wireless device 121 may, for example, indicate that carrier 1 in cell 115 experiences an RSRP of −100 dBm and that 30% of all physical resources are allocated with signals.

TABLE 1

| | | Estimated Overall DL |
|---|---|---|
| | Cell-level RSRP | Resource utilization (both |
| UE carrier/cell | measurement | data and reference signals) |
| Carrier-1-cell 115 | −100 dBm | 0.3 |
| Carrier-1- cell 116 | −90 dBm | 0.4 |
| Carrier-2 - cell 115 | −60 dBm | 0.4 |
| Carrier-2- cell 116 | −70 dBm | 0.5 |

Next, since the first wireless device 121 reports reception, or hearability, of cell 116, the first network node 110 may request the second network node 111 serving cell 116 to report its data traffic comprising the measured or predicted DL resource utilization on RF carrier 1 and 2, since this will relate to how much background RF signal energy there is available for the first wireless device 121 to harvest on RF carrier 1 and 2. Next, an background RF signal energy harvesting estimate may be determined by the first network node 110 by combining the results, e.g. in the form of a weighted sum of the radio and data traffic from both the first network node 110 and the second network node 111. Based on this background RF signal energy harvesting estimate, RF carrier 2 may be selected by the first network node 110 due to its higher estimated background energy (i.e. −100×0.3+−90×0.4<−60×0.4+−70×0.5).

FIG. 5 illustrate a sample distribution of probing resource blocks in the time-frequency domain. In FIG. 5, the ‘probing resource blocks’ are the Resource Elements, REs, that may be scheduled for probing the background RF signal energy by the first network node 110. The ‘probing resource blocks’ are denoted by the black REs in FIG. 5. Also, in FIG. 5, the ‘reference signal resource blocks’ are the REs that may be used for sending DL or UL reference signals to be used, such as SRS for channel estimation, Phase Tracking Reference Signals (PTRS) for phase noise estimation, etc. The ‘reference signal resource blocks’ are denoted by the vertically striped REs in FIG. 5. Further, the ‘data communication resource blocks’ are the REs that may be used for sending UL or DL data. The ‘data communication resource blocks’ are denoted by the non-filled REs in FIG. 5. Furthermore, the ‘energy harvesting resource blocks’ are the REs over which the first wireless device 121 may harvest RF signal energy, i.e. either from background RF signal energy or the transmitted dedicated RF energy signals.

In some embodiments, a spectrum probing system may be implemented in the first wireless device 121 and/or the first network node 110. Here, the spectrum probing system 600 may, for example, monitor the frequency spectrum by probing on specific frequencies in specific directions that are pre-determined. Based on the background RF signal energy level measurements from the spectrum probing system 600 and the reports from the first wireless device 121, an energy distribution map may be updated that indicates the level of background RF signal energy in a frequency-direction grid. This is shown in FIG. 6, wherein the intensity of the gray color represents the amount of available background RF signal energy in each specific direction and frequency slot; here, higher intensity indicates more available energy to be harvested. Then, the spectrum probing system 600 may assign a reliability score, value, or factor, to each estimated background RF signal energy value in the frequency-direction grid of the energy distribution map. This reliability score may be determined by the spectrum probing system 600 based on, for example, the number of probed wireless devices, or received feedbacks from wireless devices, for each point in the frequency-direction grid. The probing pattern may be updated based on the reliability score in the energy distribution map. For example, more probing may be scheduled over frequencies or directions for which the reliability score of the background RF signal energy estimates is low.

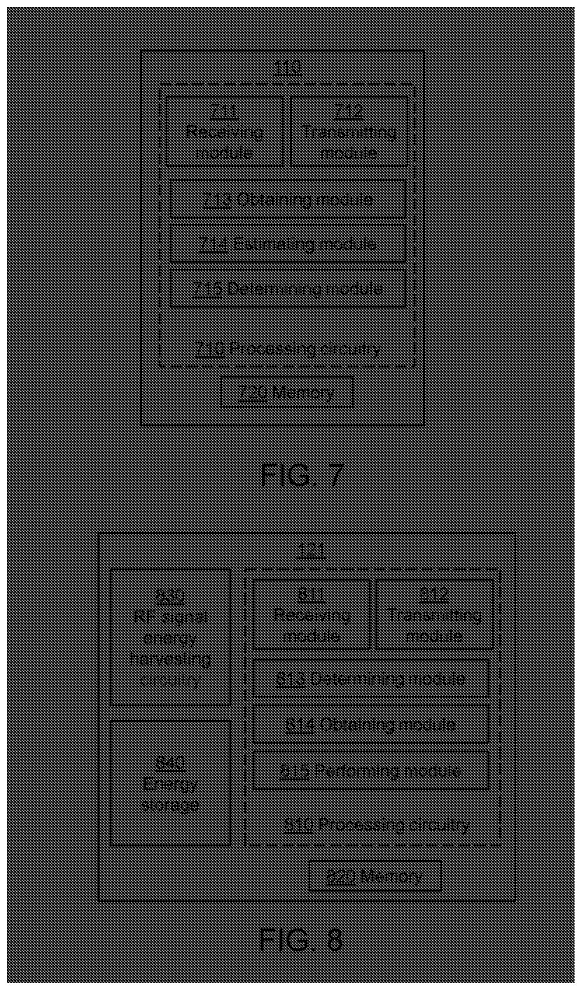

To perform the method actions in a network node 110 for enabling a first wireless device 121 to obtain background RF signal energy from background RF signals provided by the first network node 110 and/or at least one second network node 111-113 in a wireless communications network 100 on a set of time-frequency resources, the network node 110 may comprise the following arrangement depicted in FIG. 7. FIG. 7 shows a schematic block diagram of embodiments of a network node 110. The embodiments of the network node 110 described herein may be considered as independent embodiments or may be considered in any combination with each other to describe non-limiting examples of the example embodiments described herein. It should also be noted that, although not shown in FIG. 7, it should be noted that known conventional features of the network node, such as at least one antenna, a connection to a power source, e.g. an electric power grid, and a connection to the core network of the wireless communications network 100, may be assumed to be comprised in the network node 110 but is not shown or described any further in regards to FIG. 7.

The network node 110 may comprise processing circuitry 710 and a memory 720. The processing circuitry 1010 may also comprise a receiving module 711 and a transmitting module 712. The receiving module 711 and the transmitting module 712 may comprise RF circuitry and baseband processing circuitry capable of transmitting and receiving a radio signal in the wireless communications network 100. The receiving module 711 and the transmitting module 712 may also form part of a single transceiver. It should also be noted that some or all of the functionality described in the embodiments above as being performed by the network node 110 may be provided by the processing circuitry 710 executing instructions stored on a computer-readable medium, such as the memory 720 shown in FIG. 7. Alternative embodiments of the network node 110 may comprise additional components, such as an obtaining module 713, estimating module 714, and determining module 715 responsible for providing its functionality to support the embodiments described herein.

The network node 110 or processing circuitry 710 is configured to, or may comprise the estimating module 714 configured to, estimate a background RF signal energy available to the first wireless device 121 in each time-frequency resource in the set of time-frequency resources. Also, the network node 110 or processing circuitry 710 is configured to, or may comprise the determining module 712 configured to, determine a first subset of the set of time-frequency resources that the first wireless device (121) is to use for obtaining background RF signal energy based on the estimated background RF signal energy. Furthermore, the network node 110 or processing circuitry 710 is configured to, or may comprise the transmitting module 712 configured to, transmit information indicating the determined first subset of the time-frequency resources to the first wireless device 121. In some embodiments, the first subset of the set of time-frequency resources may be estimated to comprise a higher level of background RF signal energy than at least one second subset of the set of time-frequency resources and/or the level of background RF signal energy in the first subset of the set of time-frequency resources is above a determined threshold value.

In some embodiments, the network node 110 or processing circuitry 710 may be configured to, or may comprise the estimating module 714 configured to, estimate the background RF signal energy by aggregating an estimated background RF signal energy from each of the first network node 110 and/or the at least one second network node 111-113 for each time-frequency resource in the set of time-frequency resources. According to some embodiments, the network node 110 or processing circuitry 710 may be configured to, or may comprise the estimating module 714 configured to, estimate the background RF signal energy based on information indicating background RF signal quality measurements performed on each time-frequency resource in the set of time-frequency resources, and/or background RF signal quality estimations for each time-frequency resource in the set of time-frequency resources.

In some embodiments, the network node 110 or processing circuitry 710 may be configured to, or may comprise the transmitting module 712 configured to, transmit, to the first wireless device 121, information indicating that background RF signal quality measurements on each time-frequency resource in the set of time-frequency resources, and/or background RF signal quality estimations on each time-frequency resource in the set of time-frequency resources, is to be performed. Here, in some embodiments, the network node 110 or processing circuitry 710 may be configured to, or may comprise the receiving module 711 configured to, receive, from the first wireless device 121, information indicating background RF signal quality measurements performed on each time-frequency resource in the set of time-frequency resources, and/or background RF signal quality estimations on each time-frequency resource in the set of time-frequency resources.

According to some embodiments, the network node 110 or processing circuitry 710 may be configured to, or may comprise the estimating module 714 configured to, estimate the background RF signal energy based on one or more of: predicted signal quality values for specific reference signals performed by the first network node 110 for the first wireless device 121; predicted signal quality values for specific reference signals performed by the first wireless device 121; and signal measurements performed by the first network node 110 on Uplink, UL, signal transmissions from the first wireless device 121. Optionally, in some embodiments, the network node 110 or processing circuitry 710 may be configured to, or may comprise the estimating module 714 configured to, estimate the background RF signal energy based on information indicating measured or predicted RF signal load at the at least one second network node 111-113 on each time-frequency resource in the set of time-frequency resources.

In some embodiments, the network node 110 or processing circuitry 710 may be configured to, or may comprise the transmitting module 712 configured to, transmit, to the at least one second network node 111-113, information requesting measured or predicted RF signal load at the least one second network node 111-113 on each time-frequency resource in the set of time-frequency resources. Here, in some embodiments, the network node 110 or processing circuitry 710 may be configured to, or may comprise the receiving module 711 configured to, receive, from the at least one second network node 111-113, information indicating measured or predicted RF signal load at the least one second network node 111-113 on each time-frequency resource in the set of time-frequency resources. In this case, according to some embodiments, the transmitted information comprise the location of the first wireless device 121 in the wireless communications network 100, and the received information comprise information indicating an estimated RF signal energy provided by the least one second network node 111-113 on each time-frequency resource in the set of time-frequency resources for the location of the first wireless device 121 in the wireless communications network 100.

According to some embodiments, the network node 110 or processing circuitry 710 may be configured to, or may comprise the estimating module 714 configured to, estimate the background RF signal energy by probing the background RF signal energy from background RF signals transmitted by the at least one network node 111-113 on each time-frequency resource in the set of time-frequency resources. In this case, according to some embodiments, the network node 110 or processing circuitry 710 may be configured with, or may comprise the estimating module 714 configured with, a machine learning model that is trained to estimate the background RF signal energy from each of the first network node 110 and/or the at least one second network node 111-113 on other time-frequency resources than the set of time-frequency resources based on the probed RF signal energy from background RF signals transmitted by the at least one network node 111-113 on each time-frequency resource in the set of time-frequency resources.

In some embodiments, the network node 110 or processing circuitry 710 may be configured to, or may comprise the receiving module 711 configured to, receive, from the first wireless device 121, information requesting a first subset of the set of time-frequency resources to use for obtaining background RF signal energy. In this case, according to some embodiments, the information requesting a first subset of the set of time-frequency resources comprise one or more capabilities of the first wireless device 121 for obtaining background RF energy from background RF signals received on the set of time-frequency resources. Here, in some embodiments, the network node 110 or processing circuitry 710 may be configured to, or may comprise the determining module 715 configured to, determine the first subset of the set of time-frequency resources based on the one or more capabilities of the first wireless device 121 for obtaining background RF signal energy from background RF signals received on the set of time-frequency resources.

In some embodiments, the network node 110 or processing circuitry 710 may be configured to, or may comprise the receiving module 711 configured to, receive, from the first wireless device 121, information indicating the amount of background RF signal energy obtained by the first wireless device 121 from the background RF signals on the determined first subset of the set of time-frequency resources. In this case, according to some embodiments, the network node 110 or processing circuitry 710 may be configured with, or may comprise the estimating module 714 configured with, a machine learning model that is trained to estimate which one or more subsets in the set of time-frequency resources that will provide the highest amount of background RF signal energy based on: information, received from the first wireless device 121, indicating an amount of background RF signal energy obtained by the first wireless device 121 from background RF signals received on the first subset of the set of time-frequency resources; and the estimated background RF signal energy from each of the first network node 110 and/or the at least one second network node 111-113 in each time-frequency resource in the set of time-frequency resources. In this case, according to some embodiments, the estimated one or more subsets in the set of time-frequency resources is subsequently used when determining the first subset of the set of time-frequency resources for other wireless devices 122 in the wireless communications network 100.

Furthermore, the embodiments for enabling a first wireless device 121 to obtain background RF signal energy from background RF signals provided by the first network node 110 and/or at least one second network node 111-113 in a wireless communications network 100 on a set of time-frequency resources described above may be implemented through one or more processors, such as the processing circuitry 710 in the network node 110 depicted in FIG. 7, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 710 in the network node 110. The computer program code may e.g. be provided as pure program code in the network node 110 or on a server and downloaded to the network node 110. Thus, it should be noted that the modules of the network node 110 may in some embodiments be implemented as computer programs stored in memory, e.g. in the memory modules 720 in FIG. 7, for execution by processors or processing modules, e.g. the processing circuitry 710 of FIG. 7.

To perform the method actions in a first wireless device 121 for obtaining Radio Frequency, RF, signal energy from background RF signals provided by a first network node 110 and/or at least one second network node 111-113 in a wireless communications network 100 on a set of time-frequency resources, the first wireless device 121 may comprise the following arrangement depicted in FIG. 8. FIG. 8 shows a schematic block diagram of embodiments of a first wireless device 121. The embodiments of the first wireless device 121 described herein may be considered as independent embodiments or may be considered in any combination with each other to describe non-limiting examples of the example embodiments described herein. It should also be noted that, although not shown in FIG. 8, it should be noted that known conventional features of a wireless device, such as at least one antenna and a power source, e.g. a battery, may be assumed to be comprised in the first wireless device 121 but is not shown or described any further in regards to FIG. 8.

The first wireless device 121 may comprise processing circuitry 810 and a memory 820. The processing circuitry 810 may also comprise a receiving module 811 and a transmitting module 812. The receiving module 811 and the transmitting module 812 may comprise Radio Frequency, RF, circuitry and baseband processing circuitry capable of transmitting and receiving a radio signal in the wireless communications network 100. The receiving module 811 and the transmitting module 812 may also form part of a single transceiver. It should also be noted that some or all of the functionality described in the embodiments above as being performed by the first wireless device 121 may be provided by the processing circuitry 810 executing instructions stored on a computer-readable medium, such as the memory 820 shown in FIG. 8. Alternative embodiments of the first wireless device 121 may comprise additional components, such as a determining module 813, obtaining module 814, and performing module 815 responsible for providing its functionality to support the embodiments described herein. Furthermore, the first wireless device 121 may also comprise an RF signal energy harvesting module 830 and an energy storage 840, e.g. a battery. The RF signal energy harvesting circuitry 830 may comprise, for example, a rectifying circuit, a low-pass filter and a storage device (such as capacitors) capable of converting obtained or harvested RF signal energy to stored energy. The energy may, for example, be stored in the energy storage 840, such as a battery. However, other types of RF signal energy harvesting circuitries may also be envisioned.

The first wireless device 121 or processing circuitry 810 is configured to, or may comprise the receiving module 811 configured to, receive information indicating a first subset of the set of time-frequency resources that the first wireless device 121 is to use for obtaining RF signal energy. Also, the first wireless device 121 or processing circuitry 810 is configured to, or may comprise the obtaining module 814 configured to, obtain RF signal energy from background RF signals received on the first subset of the set of time-frequency resources.

In some embodiments, the first wireless device 121 or processing circuitry 810 may be configured to, or may comprise the receiving module 811 configured to, receive information indicating that background RF signal quality measurements on each time-frequency resource in the set of time-frequency resources, and/or an estimated background RF signal quality on each time-frequency resource in the set of time-frequency resources, is to be performed. Here, in some embodiments, the first wireless device 121 or processing circuitry 810 may be configured to, or may comprise the performing module 815 configured to, perform background RF signal quality measurements on each time-frequency resource in the set of time-frequency resources, and/or background RF signal quality estimations on each time-frequency resource in the set of time-frequency resources. In this case, according to some embodiments, the first wireless device 121 or processing circuitry 810 may be configured to, or may comprise the transmitting module 812 configured to, transmit information indicating performed background RF signal quality measurements on each time-frequency resource in the set of time-frequency resources, and/or an estimated background RF signal quality on each time-frequency resource in the set of time-frequency resources. Optionally, according to some embodiments, the first wireless device 121 or processing circuitry 810 may be configured with, or may comprise the performing module 815 configured with, a machine learning model that is trained to estimate the background RF signal quality on each time-frequency resource in the set of time-frequency resources based on previously performed background RF signal quality measurements on each time-frequency resource in the set of time-frequency resources.

In some embodiments, the first wireless device 121 or processing circuitry 810 may be configured to, or may comprise the determining module 813 configured to, determine that the first wireless device 121 is to obtain background RF signal energy from received background RF signals. In this case, according to some embodiments, the first wireless device 121 or processing circuitry 810 may be configured to, or may comprise the transmitting module 812 configured to, transmit information requesting a first subset of the set of time-frequency resources to use for obtaining background RF signal energy. Here, according to some embodiments, the information requesting a first subset of the set of time-frequency resources further comprise information indicating one or more capabilities of the first wireless device 121 to obtain background RF energy from background RF signals received on the set of time-frequency resources.

In some embodiments, the first wireless device 121 or processing circuitry 810 may be configured to, or may comprise the determining module 813 configured to, determine that the first wireless device 121 is to obtain background RF signal energy by probing the background RF signal energy levels of one or more subsets of the set of time-frequency resources in order to estimate the total background RF signal energy in the one or more subsets of the set of time-frequency resources. Here, in some embodiments, the first wireless device 121 or processing circuitry 810 may be configured to, or may comprise the determining module 813 configured to, determine that the first wireless device 121 is to obtain background RF signal energy from RF signals on the one or more subsets of the set of time-frequency resources if the estimated total background RF signal energy on the one or more subsets of the set of time-frequency resources is above a determined threshold value. In this case, according to some embodiments, the first wireless device 121 or processing circuitry 810 may be configured with, or may comprise the determining module 813 configured with, a machine learning model that is trained to estimate the total background RF signal energy on the one or more subsets of the set of time-frequency resources one or more subsequent time periods based on the probed background RF signal energy levels for each of the one or more subsets of the set of time-frequency resources.

In some embodiments, the first wireless device 121 or processing circuitry 810 may be configured to, or may comprise the determining module 813 configured to, determine that the first wireless device 121 is to obtain background RF signal energy by performing radio signal quality predictions in order to estimate the total background RF signal energy in one or more subsets of the set of time-frequency resources. Here, in some embodiments, the first wireless device 121 or processing circuitry 810 may be configured to, or may comprise the determining module 813 configured to, determine that the first wireless device 121 is to obtain background RF signal energy from RF signals on the one or more subsets of the set of time-frequency resources if the estimated total background RF signal energy on the one or more subsets of the set of time-frequency resources is above a determined threshold value.

According to some embodiments, the first wireless device 121 or processing circuitry 810 may be configured to, or may comprise the transmitting module 812 configured to, transmit information indicating the amount of background RF signal energy obtained by the first wireless device 121 from the background RF signals on the first subset of the set of time-frequency resources. Also, according to some embodiments, the set of time-frequency resources may be downlink, DL, or uplink, UL, time-frequency resources. Further, according to some embodiments, the background RF signals are RF signals transmitted on the set of time-frequency resources that are not specifically dedicated for transmissions to or from the first wireless device 121.

Furthermore, the embodiments for obtaining Radio Frequency, RF, signal energy from background RF signals provided by a first network node 110 and/or at least one second network node 111-113 in a wireless communications network 100 on a set of time-frequency resources described above may be implemented through one or more processors, such as the processing circuitry 810 in the first wireless device 121 depicted in FIG. 8, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 810 in the first wireless device 121. The computer program code may e.g. be provided as pure program code in the first wireless device 121 or on a server and downloaded to the first wireless device 121. Thus, it should be noted that the modules of the first wireless device 121 may in some embodiments be implemented as computer programs stored in memory, e.g. in the memory modules 820 in FIG. 8, for execution by processors or processing modules, e.g. the processing circuitry 810 of FIG. 8.

Those skilled in the art will also appreciate that the processing circuitries 710, 810 and the memories 720, 820 described above may refer to a combination of analog and digital circuits, and/or one or more processors configured with software and/or firmware, e.g. stored in a memory, that when executed by the one or more processors such as the processing circuitries 710, 810 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures and program modules represent examples of program code for executing steps of the methods disclosed herein. The particular sequence of such executable instructions or associated data structures represents examples of corresponding acts for implementing the functions described in such steps or processes. The embodiments herein are not limited to the above described preferred embodiments. Various alternatives, modifications and equivalents may be used. Therefore, the above embodiments should not be construed as limiting.

1.-68. (canceled)

69. A method performed by a first network node for enabling a first wireless device to obtain background Radio Frequency, RF, signal energy from background RF signals provided by one or both of the first network node and at least one second network node in a wireless communications network on a set of time-frequency resources, the method comprising:
receiving, from the first wireless device, information requesting a first subset of the set of time-frequency resources to use for obtaining background RF signal energy, the information requesting a first subset of the set of time-frequency resources comprising one or more capabilities of the first wireless device for obtaining background RF energy from background RF signals received on the set of time-frequency resources;
estimating a background RF signal energy available to the first wireless device in each time-frequency resource in the set of time-frequency resources;
determining a first subset of the set of time-frequency resources that the first wireless device is to use for obtaining background RF signal energy based on the estimated background RF signal energy and based on the one or more capabilities of the first wireless device for obtaining background RF signal energy from background RF signals received on the set of time-frequency resources; and
transmitting information indicating the determined first subset of the time-frequency resources to the first wireless device.

70. The method according to claim 69, wherein the estimating is performed by aggregating an estimated background RF signal energy from one or both of (A) each of the first network node and (B) the at least one second network node for each time-frequency resource in the set of time-frequency resources.

71. The method according to claim 69, wherein the estimating is based on one or both of information indicating background RF signal quality measurements performed on each time-frequency resource in the set of time-frequency resources and background RF signal quality estimations for each time-frequency resource in the set of time-frequency resources.

72. The method according to claim 71, further comprising
transmitting, to the first wireless device, the one or both of the information indicating that background RF signal quality measurements on each time-frequency resource in the set of time-frequency resources and the background RF signal quality estimations on each time-frequency resource in the set of time-frequency resources, is to be performed; and
receiving, from the first wireless device, the one or both of the information indicating background RF signal quality measurements performed on each time-frequency resource in the set of time-frequency resources and the background RF signal quality estimations on each time-frequency resource in the set of time-frequency resources.

73. The method according to claim 69, wherein the estimating is based on one or more of:
predicted signal quality values for specific reference signals performed by the first network node for the first wireless device;
predicted signal quality values for specific reference signals performed by the first wireless device; and
signal measurements performed by the first network node on Uplink, UL, signal transmissions from the first wireless device.

74. The method according to claim 69, wherein the estimating is based on information indicating measured or predicted RF signal load at the at least one second network node on each time-frequency resource in the set of time-frequency resources.

75. The method according to claim 69, further comprising receiving, from the first wireless device, information indicating the amount of background RF signal energy obtained by the first wireless device from the background RF signals on the determined first subset of the set of time-frequency resources.

76. A first network node for enabling a first wireless device to obtain background Radio Frequency, RF, signal energy from background RF signals provided by one or both of the first network node and at least one second network node in a wireless communications network on a set of time-frequency resources, the first network node being configured to:
receive, from the first wireless device, information requesting a first subset of the set of time-frequency resources to use for obtaining background RF signal energy, the information requesting a first subset of the set of time-frequency resources comprising one or more capabilities of the first wireless device for obtaining background RF energy from background RF signals received on the set of time-frequency resources;
estimate a background RF signal energy available to the first wireless device in each time-frequency resource in the set of time-frequency resources;
determine a first subset of the set of time-frequency resources that the first wireless device is to use for obtaining background RF signal energy based on the estimated background RF signal energy and based on the one or more capabilities of the first wireless device for obtaining background RF signal energy from background RF signals received on the set of time-frequency resources; and
transmit information indicating the determined first subset of the time-frequency resources to the first wireless device.

77. The first network node according to claim 76, wherein the estimating is performed by aggregating an estimated background RF signal energy from one or both of (A) each of the first network node and (B) the at least one second network node for each time-frequency resource in the set of time-frequency resources.

78. The first network node according to claim 76, wherein the estimating is based on one or both of information indicating background RF signal quality measurements performed on each time-frequency resource in the set of time-frequency resources and background RF signal quality estimations for each time-frequency resource in the set of time-frequency resources.

79. The first network node according to claim 78, wherein the first network node is further configured to:
transmit, to the first wireless device, the one or both of the information indicating that background RF signal quality measurements on each time-frequency resource in the set of time-frequency resources and the background RF signal quality estimations on each time-frequency resource in the set of time-frequency resources, is to be performed; and
receive, from the first wireless device, the one or both of the information indicating background RF signal quality measurements performed on each time-frequency resource in the set of time-frequency resources and the background RF signal quality estimations on each time-frequency resource in the set of time-frequency resources.

80. The first network node according to claim 76, wherein the estimating is based on one or more of:
predicted signal quality values for specific reference signals performed by the first network node for the first wireless device;
predicted signal quality values for specific reference signals performed by the first wireless device; and
signal measurements performed by the first network node on Uplink, UL, signal transmissions from the first wireless device.

81. The first network node according to claim 76, wherein the estimating is based on information indicating measured or predicted RF signal load at the at least one second network node on each time-frequency resource in the set of time-frequency resources.

82. The first network node according to claim 76, wherein the first network node is further configured to receive, from the first wireless device, information indicating the amount of background RF signal energy obtained by the first wireless device from the background RF signals on the determined first subset of the set of time-frequency resources.

83. A method performed by a first wireless device for obtaining Radio Frequency, RF, signal energy from background RF signals provided by one or both of a first network node and at least one second network node in a wireless communications network on a set of time-frequency resources, the method comprising
determining that the first wireless device is to obtain background RF signal energy from received background RF signals;
transmitting information requesting a first subset of the set of time-frequency resources to use for obtaining background RF signal energy, the information requesting the first subset of the set of time-frequency resources further comprising information indicating one or more capabilities of the first wireless device to obtain background RF energy from background RF signals received on the set of time-frequency resources;
receiving information indicating a first subset of the set of time-frequency resources that the first wireless device is to use for obtaining RF signal energy; and
obtaining RF signal energy from background RF signals received on the first subset of the set of time-frequency resources.

84. The method according to claim 83, further comprising: receiving one or both information indicating that background RF signal quality measurements on each time-frequency resource in the set of time-frequency resources and an estimated background RF signal quality on each time-frequency resource in the set of time-frequency resources, is to be performed;
performing one or both of background RF signal quality measurements on each time-frequency resource in the set of time-frequency resources and background RF signal quality estimations on each time-frequency resource in the set of time-frequency resources; and
transmitting information indicating one or both of performed background RF signal quality measurements on each time-frequency resource in the set of time-frequency resources, and an estimated background RF signal quality on each time-frequency resource in the set of time-frequency resources.

85. The method according to claim 83, further comprising transmitting information indicating the amount of background RF signal energy obtained by the first wireless device from the background RF signals on the first subset of the set of time-frequency resources.

86. A first wireless device for obtaining Radio Frequency, RF, signal energy from background RF signals provided by one or both of a first network node and at least one second network node in a wireless communications network on a set of time-frequency resources, the first wireless device being configured to:
determine that the first wireless device is to obtain background RF signal energy from received background RF signals; transmit information requesting a first subset of the set of time-frequency resources to use for obtaining background RF signal energy, the information requesting the first subset of the set of time-frequency resources further comprising information indicating one or more capabilities of the first wireless device to obtain background RF energy from background RF signals received on the set of time-frequency resources;
receive information indicating a first subset of the set of time-frequency resources that the first wireless device is to use for obtaining RF signal energy; and
obtain RF signal energy from background RF signals received on the first subset of the set of time-frequency resources.

87. The first wireless device according to claim 86, further configured to:
receive one or both information indicating that background RF signal quality measurements on each time-frequency resource in the set of time-frequency resources and an estimated background RF signal quality on each time-frequency resource in the set of time-frequency resources, is to be performed;
perform one or both of background RF signal quality measurements on each time-frequency resource in the set of time-frequency resources and background RF signal quality estimations on each time-frequency resource in the set of time-frequency resources; and
transmit information indicating one or both of performed background RF signal quality measurements on each time-frequency resource in the set of time-frequency resources, and an estimated background RF signal quality on each time-frequency resource in the set of time-frequency resources.

88. The first wireless device according to claim 86, further configured to transmit information indicating the amount of background RF signal energy obtained by the first wireless device from the background RF signals on the first subset of the set of time-frequency resources.
